(19) United States
(12) Patent Application Publication
(10) Pub. No.: US 2011/0173758 A1
(43) Pub. Date: Jul. 21, 2011

(54) INFLATABLE MATTRESS AND METHOD OF OPERATING SAME

(76) Inventor: Ricky Jay Fontaine, Shelbyville, KY (US)

(21) Appl. No.: 13/000,205

(22) PCT Filed: Jun. 22, 2009
(86) PCT No.: PCT/US09/48131

§ 371 Date: Mar. 25, 2011

Related U.S. Application Data
(60) Provisional application No. 61/132,600, filed on Jun. 20, 2008.

(51) Int. Cl. A61G 7/057; A47C 27/08; A47C 27/14; A47C 27/10

(52) U.S. Cl. 5/709; 5/740; 5/710

(57) ABSTRACT

A body support having a number of fluid cells received within respective apertures in one or more layers of foam is described and illustrated. In some embodiments, the fluid cells are in two or more different groups, each of which can be selectively inflated and deflated to increase or decrease pressure against a user's body at different locations across the body support. Each of the fluid cells in each group can be individually surrounded by foam, can be covered by a layer of foam, and can be separated from other fluid cells in the same group by one or more fluid cells from another group. Accordingly, in some embodiments, the cells of one group can be inflated and deflated while or after the cells of another group are deflated and inflated, respectively, to reduce the opportunity for pressure points to generate discomfort of the user.

### CROSS-REFERENCE TO RELATED APPLICATIONS

Priority is hereby claimed to U.S. Provisional Patent App. No. 61/132,600 filed on Jun. 20, 2008, the entire contents of which are incorporated herein by reference.

### FIELD OF THE INVENTION

The invention relates generally to inflatable mattress systems, and particularly to a mattress assembly combining a plurality of inflatable air cells.

### BACKGROUND OF THE INVENTION

Inflatable mattresses are used in hospital rooms, old age homes, and other embodiments in which a person is required to spend long periods of time restricted to a bed or lying in a supine position. A common problem for patients requiring such long-term care is the development of decubitus ulcers, or bed sores, caused by excessive pressure applied to a patient's contact points. The patient's weight on the bed causes a counter force to be applied to the patient's body from the bed at points where the patient's body contacts the bed. Although contact points can be present across the body, it is common for sick and disabled individuals who are bed bound to develop tissue damage on the heels of the feet, on the ankle, on the hips or rear, on the shoulder blades or shoulders, and/or on other parts of the body. Tissue damage to the heels is generally the result of an individual lying in a supine position where the heels bear the weight of the legs, and the rear and shoulder blades bear the weight of the torso on the surface of the mattress. Alternatively, if the individual is in a sidelying position, the ankle will bear the weight of the legs and the hips and the shoulders bear the weight of the torso against the mattress. Often, this pressure exceeds the ability of the capillaries to circulate blood to the cells and results in an ischemic condition. The lack of blood supply to the cells causes tissue damage.

Some inflatable mattresses include horizontal air chambers extending either of the full length or the full width of the bed. These chambers are systematically inflated and deflated to inhibit the formation of bedsores. However, the chambers often lead to banding of fluid, such that bodily fluids, such as blood and lymph, are pushed back and forth along the body in one area of the body, thus inhibiting proper flow of such fluids.

### SUMMARY

In one embodiment, the invention provides a body support for supporting at least a portion of a body. The body support includes a top surface and a bottom surface spaced from the top surface and a first layer of foam defining a plurality of apertures extending between the top surface and the bottom surface. The body support further includes a first air unit at least partially inserted into one of the plurality of apertures, a second air unit at least partially inserted into one of the plurality of apertures, a pump coupled to the first air unit and the second air unit and configured to selectively move air within the first air unit and the second air unit, and a controller coupled to the pump and configured to direct air movement within the first air unit and the second air unit.

In another embodiment, the invention provides a body support for supporting at least a portion of a body. The body support includes a top surface and a bottom surface spaced from the top surface, a first side surface and a second side surface spaced from the first side surface, and a first layer of foam defining a cavity extending between the top surface and the bottom surface. The body support further includes a first air unit at least partially inserted into the cavity, a second air unit at least partially inserted into the cavity, and an air cell substantially extending between the first side surface and the second side surface. The body support further includes a pump coupled to the first air unit, the second air unit and the air cell for selectively moving air within the first air unit, the second air unit and the air cell, and a controller coupled to the pump for controlling air movement, such that the controller controls air movement within the first air unit and air movement within the second air unit independent of the first air unit, and the controller controls air movement into and out of the air cell.

In another embodiment the invention provides a body support for supporting at least a portion of a body. The body support includes a top surface and a bottom surface spaced from the top surface and a first layer of foam defining a plurality of apertures extending between the top surface to the bottom surface. The body support further includes a first air unit at least partially inserted into a first of the plurality of apertures, a second air unit at least partially inserted into a second of the plurality of apertures, a third air unit at least partially inserted into a third of the plurality of apertures, and a fourth air unit at least partially inserted into a fourth of the plurality of apertures. The body support further includes a pump coupled to the first, second, third and fourth air units for selectively moving air within the first, second, third and fourth air units, and a controller coupled to the pump for controlling air movement, such that the controller independently controls air movement within the first, second, third and fourth air units, and the first, second, third and fourth air units are adjusted to promote flow of bodily fluid of a user. Other aspects of the invention will become apparent by consideration of the detailed description and accompanying drawings.

### BRIEF DESCRIPTION OF THE DRAWINGS

FIG. 1 is a perspective view of a body support according to some embodiments of the present invention.

FIG. 2 is a cross-sectional view of a body support according to some embodiments of the present invention along line 2-2 of FIG. 1.

FIG. 3 is a cross-sectional view of the body support of FIG. 2 along line 3-3 of FIG. 2.

FIG. 4 is a side view of the air pods of FIG. 3 shown in both a first position and a second position.

FIG. 5 is side view of an air cell according to some embodiments of the present invention.

FIG. 6 is a top view of the air cell of FIG. 5.

FIG. 7 is a bottom view of the air cell of FIG. 5.

FIG. 8 is perspective view of an air cell according to some embodiments of the present invention.

FIG. 9 is a bottom view of the air cell of FIG. 8.

FIG. 10 is a side view of the air cell of FIG. 8.

FIG. 11 is a top view of the body support shown in FIG. 2 and further including a control system.

FIG. 12 is an end view of the body support shown in FIG. 2 and further including air chambers.

FIG. 13 is a top view of a body support according to some embodiments of the present invention and further including a control system and a plurality of air cells.

FIG. 14 is a top view of a foam layer that can matingly engage the air cells of FIG. 13.

FIG. 15 is an end view of the foam layer of FIG. 14.

FIG. 16 is a bottom view of a body support of FIG. 13.

FIG. 17 is an exploded view of the body support of FIGS. 13-16.

FIG. 18 is a cross-sectional view of the body support of FIG. 13 along line 18-18 of FIG. 16.

FIG. 19 is a side view of the body support of FIG. 13.

FIG. 20 is a partial exploded view of the body support of FIG. 13.

FIG. 21 is an end view of a first end of the body support of FIG. 13.

FIG. 22 is an end view of a second end of the body support of FIG. 13.

FIG. 23 is a cross-sectional view of the body support of FIG. 13 along line 23-23 of FIG. 16.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

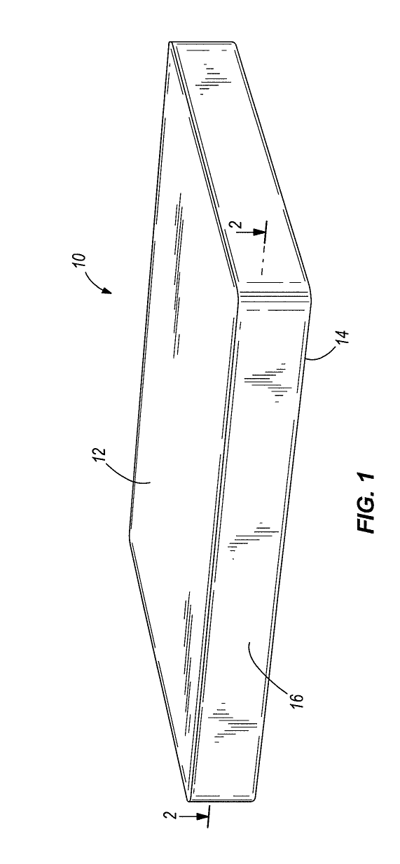

A body support 10 according to an embodiment of the present invention is illustrated in FIGS. 1-4. The body support 10 includes a top surface 12 configured to support a user and a bottom surface 14 configured to be proximate to a frame, floor, or other similar surface. The body support 10 can further include a first side surface 16 and a second side surface 18. The body support 10 can include one or more layers of foam or other similar resilient material. The particular arrangement or configuration of the body support 10 is not intended to limit the scope of the present invention. Rather, the arrangement of the body support 10 is given by way of example only.

The body support 10 is illustrated in FIGS. 1-3 as a mattress. However, in other embodiments, the body support can include, but not be limited to, a mattress topper, overlay, or futon. It will be appreciated that the features of the body support 10 described above are applicable to any other type of body support having any size and shape. By way of example only, these features are equally applicable to head pillows, seat cushions, seat backs, neck pillows, leg spacer pillows, and any other element used to support or cushion any part or all of a human or animal body. Accordingly, as used herein and in the appended claims, the term “body support” is intended to refer to any and all of such elements (in addition to mattresses, mattress toppers, overlays, or futons). It should also be noted that each of the body supports described and illustrated herein is presented in a particular form, such as a mattress, mattress topper, overlay, futon, or pillow. However, absent description herein to the contrary, any or all of the features of each such body support can be applied to any other type of body support having any other shape and size, including the various types of body supports mentioned above.

The body support 10 can include one or more layers of foam in stacked relation. The body support 10 can include a top layer 20, a first middle layer 22, a second middle layer 24 and a bottom layer 26. In some embodiments, the first middle layer 22 and the second middle layer 24 are combined. Other combinations of layers, quantities of layers and materials can be included in the body support 10.

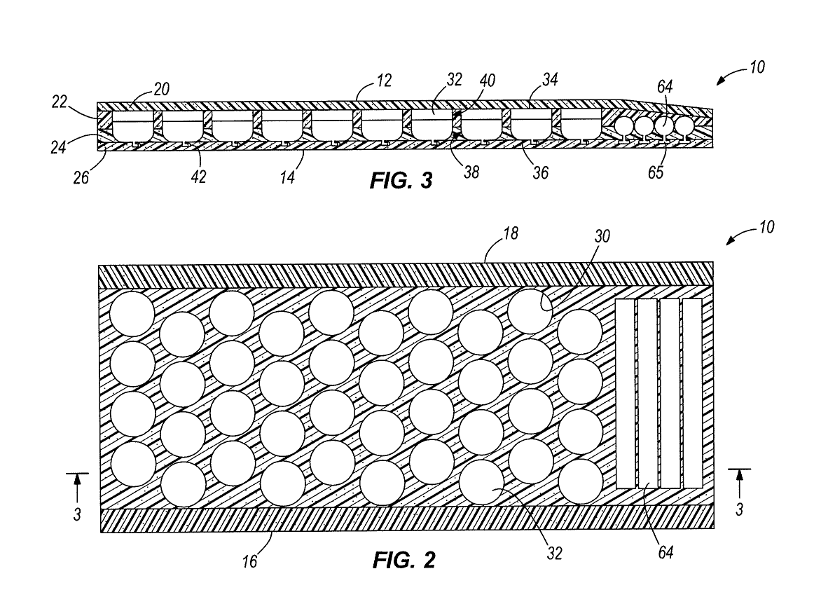

One or both of the first middle layer 22 and the second middle layer 24 can define a plurality of apertures 30 therein. In some embodiments, these apertures 30 are at least partially interconnected to form a cavity. The plurality of apertures 30 can include channels extending therebetween to form at least one cavity that comprises multiple apertures 30. The apertures 30 can be die cut, drilled out, or otherwise machined out of one or more of the layers 22, 24, or the layers 22, 24 can be formed to include the apertures. As illustrated in FIGS. 2-4, the apertures 30 can be substantially circular, but in other non-illustrated embodiments, the apertures 30 can be non-circular, such as ovular, square, rectangular, triangular, or other regular or non-regular shapes.

In some embodiments, the top layer 20, the first middle layer 22, the second middle layer 24, and the bottom layer 26 can rest upon each other without being secured thereto. However, in other embodiments, some or all of the layers 20, 22, 24 and 26 are secured to one another by an adhesive or cohesive bonding material, or other type of fastener. Any of layers 20, 22, 24, 26 can comprise visco-elastic foam that is reticulated or non-reticulated. By way of example, in some embodiments the top layer 20 and/or the apertured layer(s) (e.g., 22 and 24, in the illustrated embodiment) are visco-elastic foam.

A plurality of cells 32 are illustrated in FIGS. 2-4, each of which are at least partially inserted into an aperture 30. Each cell 32 contains an amount of fluid in an internal chamber of each cell 32. The fluid can be air in some embodiments. However, in other embodiments, the fluid can be any gas or combination of gasses. In still other embodiments, the fluid can be liquid or a combination of liquid and gas. By way of example only, the cells 32 in the illustrated embodiments contain air, and are therefore referred to herein simply as “air cells” or “air units”, it being understood that the terms “fluid cells” or “fluid units” encompass any of the gas and/or liquid contents described above.

In embodiments that include at least one cavity, a plurality of air units 32 are inserted into each cavity. In some embodiments, the apertures 30 are all interconnected to form a single cavity, such that the plurality of air units 32 are all inserted into the single cavity. The air units 32 can be positioned close together to properly support the top layer 20 thereon.

The illustrated air units 32 include an upper surface 34 adjacent the top layer 20 and a lower surface 36 adjacent the bottom layer 26. The illustrated air units 32 define a substantially vertical cylindrical portion 38 (with a vertical axis (not shown) extending longitudinally through the unit 32) and a bellows-shaped portion 40. The bellows-shaped portion 40 can include a variable diameter, such that at least one portion of the bellows-shaped portion 40 has a smaller diameter than another portion. This variable diameter permits the bellows-shaped portion 40 to expand and contract, while the changing diameter portions fold and unfold. In the illustrated embodiment, the larger and smaller diameter portions include substantially sharp angles as the diameter changes from smaller to larger and back to smaller. Other shapes, configurations and arrangements of air units are possible, and the embodiment illustrated in FIGS. 2-4 is given by way of example only.

By virtue of their positions within the apertures 30, each of the air units 32 in the illustrated embodiment of FIGS. 1-4 is surrounded (e.g., encircled or covered on all vertical sidewalls) by the apertured foam layer(s) 22, 24, and is covered by the top layer 20. Therefore, each air unit 32 in the illustrated embodiment of FIGS. 1-4 is separated from adjacent air units by foam from the apertured foam layer(s) 22, 24.

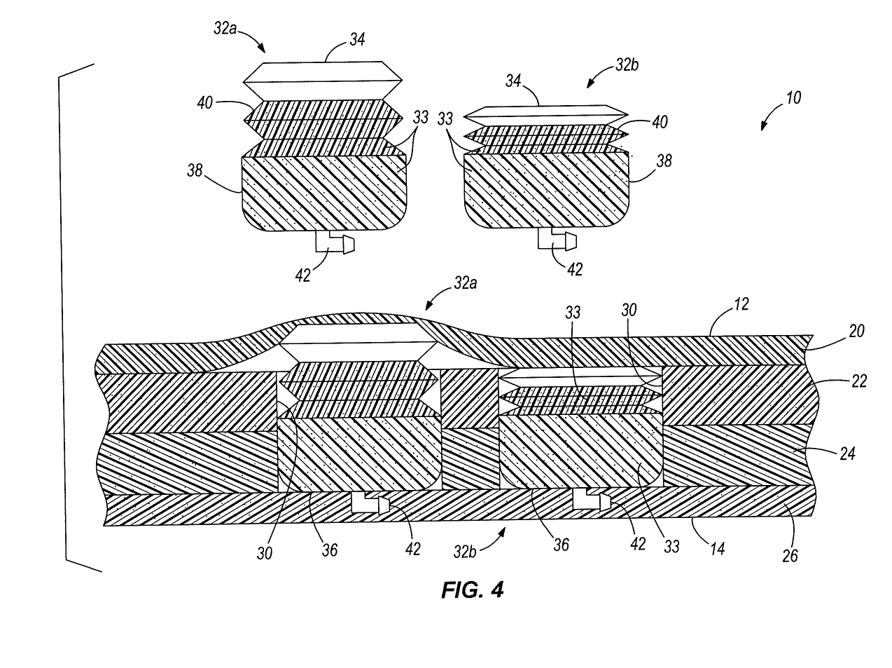

In some embodiments, the air units 32 contain foam 33. The foam 33 within each air unit 32 can be in the form of one or more layers as shown in FIG. 4, or can be foam in any other form. Also, the foam 33 can occupy any amount of each air unit 32, such as by completely filling each air unit 32 when in a deflated state (as described in greater detail below), by occupying only a bottom portion of each air unit 32, and the like. In some embodiments, one or more layers of foam 33 within the air units 32 can be dimensioned to occupy the space within the air unit at any given height of the air unit 32.

In those embodiments in which some or all of the air units 32 contain foam 33, the foam can include one or more layers of reticulated or non-reticulated visco-elastic foam. For example, in the illustrated embodiment of FIGS. 1-4, foam 33 within each air unit 32 can include two layers of different types of foam, such as a bottom layer of reticulated foam that is visco-elastic or non-visco-elastic, and a top layer of another type of foam (e.g., non-reticulated foam that is either visco-elastic or non-visco-elastic). In other embodiments, these two layers can be reversed in position.

The air units 32 can be positioned between the top layer 20 and the bottom layer 26, such that the upper surface 34 of the air unit 32 substantially abuts the top layer 20 and the lower surface 36 of the air unit 32 substantially abuts the bottom layer 26, as illustrated in FIG. 4. FIG. 4 further illustrates a first air unit 32a in an inflated position and a second air unit 32b in a deflated position. The vertical cylindrical portion 38 can maintain substantially the same size and shape during inflation and deflation of the air units 32a, 32b, as shown in FIG. 4. The bellows-shaped portion 40 can expand and contract as the air units 32 move between an inflated position and a deflated position.

When the air units 32 are inflated, the bellows-shaped portion 40 can push against the top layer 20 to raise the top layer 20 a corresponding height. When the air units 32 are deflated, the bellows-shaped portion 40 can lower the top layer 20 a corresponding height to allow the top layer 20 to remain substantially flat, as illustrated FIG. 4. In other embodiments, the inflated position permits the top layer 20 to lie substantially flat, and the deflated position permits the top layer 20 to sink down below the top surface 12 of the body support 10. In some embodiments, the difference in height between the first air unit 32a and the second air unit 32b is substantially about 1.5 inches (about 3.8 centimeters). In other embodiments, the difference in height between the first air unit 32a and the second air unit 32b can be as little as about 0.5 inches (about 1.27 cm) and as great as about 3 inches (about 7.62 cm).

In some embodiments, when the bellows-shaped portion 40 is raised a first height, it raises the top layer 20 a second height, which relates to the first height. The top layer 20 can partially compress in response to pressure from the bellows-shaped portion 40, thus the first height is often not equal to the second height. However, the first height corresponds to (i.e. is related to) the second height. In some embodiments, the second height is a ratio of the first height, whereas in other embodiments, the second height is a percentage of the first height.

In some embodiments, when a first of the bellows-shaped portions 40 is raised, a second of the bellows-shaped portions 40 is lowered. This can be especially true in the non-powered applications. The height the first bellows-shaped portion 40 is raised can be identical to or related to the height the second bellows-shaped portion 40 is lowered. Some embodiments couple a single bellows-shaped portion 40 to a pair of bellows-shaped portions 40, such that the single bellows-shaped portion 40 raises and the pair of bellows-shaped portions 40 lower simultaneously. In such embodiments, the single bellows-shaped portion 40 can raise twice the distance than the distance lowered by the pair of bellows-shaped portions 40.

The air units 32 can have a movement cycle of moving up and down, such that the cycle rate can be between about 10 seconds to about 5 minutes, although shorter and longer cycle rates are possible, in other embodiments. A user interface can be included which permits the user to set the cycle rate and, in some embodiments, the height range for inflation and deflation.

The air units 32 can also include a port or spout 42 (both terms used interchangeably herein to indicate a structure or element through which fluid entering and/or exiting the air units 32 passes) coupled adjacent the lower surface 36 to permit air or fluid to flow into and out of each air unit 32. The spout 42 can be coupled to the air units 32 to permit entry and egress of fluid therethrough. The spout 42 can be coupled to a pump, compressor, blower, motor or other similar fluid movement device, as will be discussed in detail below. The air units 32 can be linked to each other to move a set quantity of fluid between the air units 32 in response to pressure on each air unit 32. In some embodiments, a check valve can be used to prevent most or all of the fluid from flowing out of the air units 32 in response to the weight of the user. Also, in some embodiments, the check valve can be a static/dynamic check valve. The illustrated spout 42 is positioned within the bottom layer 26; however, in other embodiments, the spout 42 can be positioned above or below the bottom layer 26. It is to be understood that the spout can be positioned anywhere on the air unit 32 to permit the passage or air or fluid therethrough, and is illustrated adjacent the lower surface 36 by way of example only.

The embodiment of FIGS. 1-4 can further include a plurality of air cells 64 operable to support feet, ankles, and in some embodiments, legs of a user. The air cells 64 can extend across a portion of the body support 10 (see FIG. 3). The air cells 64 can be inflatable and can each have a spout 65 coupled thereto to receive and dispense air therefrom. In some embodiments, the air cells 64 can be coupled to a pump, compressor, blower, motor or other similar fluid movement device, as will be discussed in detail below. The air cells 64 can share a fluid movement device with the air units 32 or can have a dedicated device. The air cells 64 can be linked to each other to move a set quantity of fluid between the air cells 64 in response to the pressure on each air cell 64. In some embodiments, a check valve can be used to prevent most or all of the fluid from flowing out of the air cells 64 in response to the weight of the user. In some embodiments, the check valve can be a static/dynamic check valve. The illustrated spout 65 is positioned within the bottom layer 26; however, in other embodiments, the spout 65 can be positioned above or below the bottom layer 26. It is to be understood that the spout can be positioned anywhere on the air cell 64 to permit the passage or air or fluid therethrough, and is illustrated adjacent the lower surface 36 by way of example only.

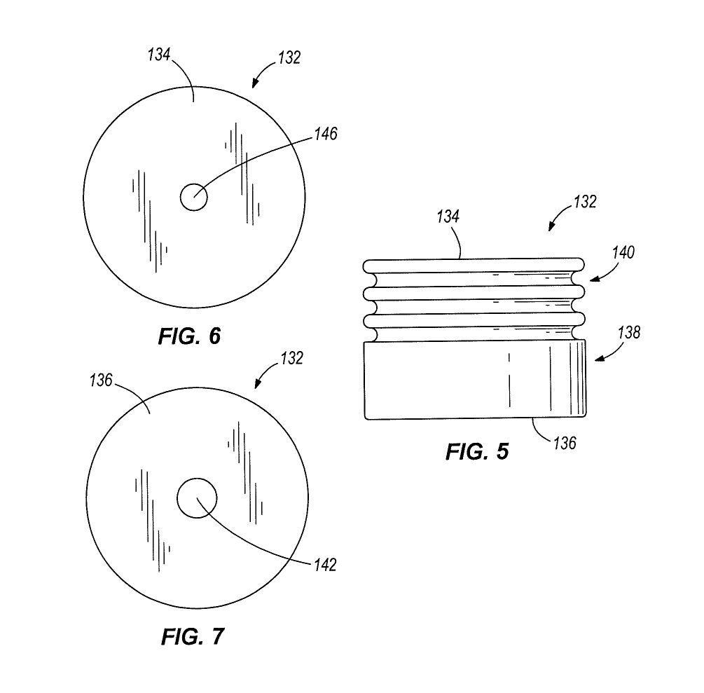

FIGS. 5-7 illustrate another embodiment of an air unit 132 according to the present invention. This embodiment employs much of the same structure and has many of the same properties as the embodiments of the air unit 32 described above in connection with FIGS. 1-4. Accordingly, the following description focuses primarily upon structure and features that are different than the embodiments described above in connection with FIGS. 1-4. Reference should be made to the description above in connection with FIGS. 1-4 for additional information regarding the structure and features, and possible alternatives to the structure and features of the air unit 132 illustrated in FIGS. 5-7 and described below. Features and elements in the embodiment of FIGS. 5-7 corresponding to features and elements in the embodiments described above in connection with of FIGS. 1-4 are numbered in the 100 series of reference numbers.

The air unit 132 illustrated in FIGS. 5-7 includes an air unit upper surface 134, an air unit lower surface 136, which can be positioned to engage at least one layer of a body support 110. The air unit 132 further includes a vertical cylindrical portion 138 and a bellows-shaped portion 140. In some embodiments, the vertical cylindrical portion 138 is at least partially filled with a substantially cylindrical foam piece 144, whereas the bellows-shaped portion 140 is substantially void of foam. The bellows-shaped portion can include a variable diameter, such that at least one portion of the bellows-shaped portion 140 has a smaller diameter than another portion. This variable diameter permits the bellows-shaped portion 140 to expand and contract, while the changing diameter portions fold and unfold. In the illustrated embodiment, the larger and smaller diameter portions include alternating concave and convex curved portions as the diameter changes from smaller to larger and back to smaller. Other shapes, configurations and arrangements of air units are possible, and the embodiment illustrated in FIGS. 5-7 is given by way of example only.

FIG. 6 illustrates an optional air migration hole 146 on the air unit upper surface 134, that can selectively permit fluid to enter and exit the air unit 132. In some embodiments, fluid flows through the air migration hole 146 in response to the weight of a user, to permit adjustment of pressure in the air units 132. In other embodiments, the air migration hole 146 is primarily a fluid outlet, to permit deflation of the air unit 132.

FIG. 7 illustrates a spout 142 on the air unit lower surface 136, that can permit fluid to enter and exit the air unit 132. In some embodiments, fluid enters the air unit 132 primarily or exclusively through the spout 142. In some embodiments, the spout 142 is coupled to a pump, compressor, blower, motor or other similar fluid moving device, which will be described in detail below. The illustrated spout 142 is an aperture in the air unit 132. In other embodiments, the spout 142 includes a protruding member that can be coupled to a pump, blower, motor and the like, by a length of conduit. The pump, blower, motor and the like can inflate and/or deflate the air unit 132 via the conduit.

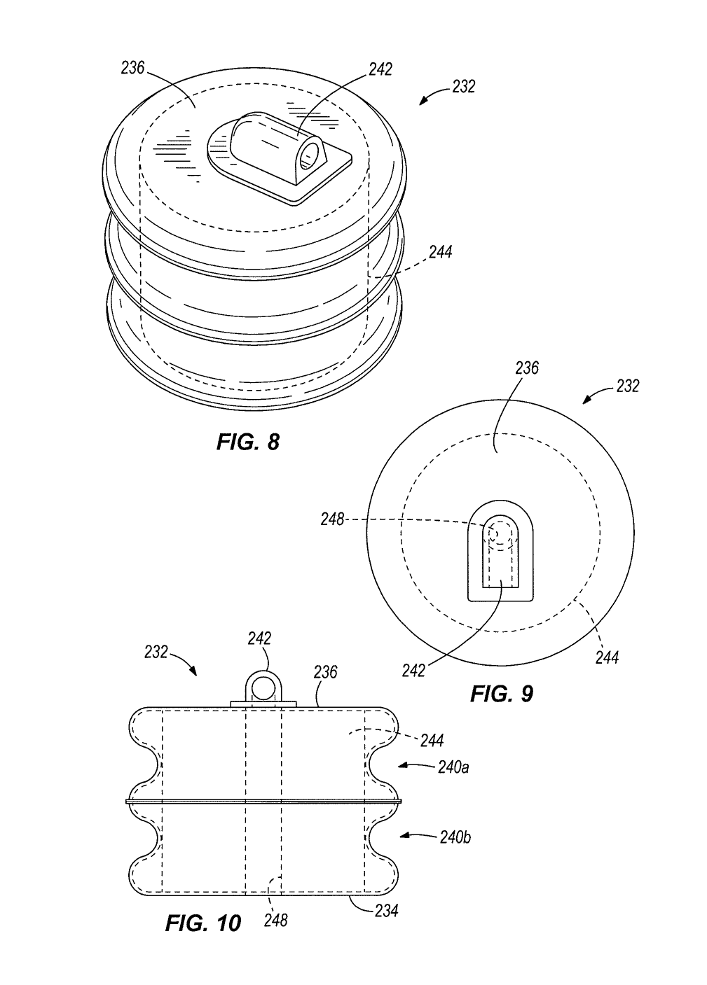

FIGS. 8-10 illustrate another embodiment of an air unit 232 according to the present invention. This embodiment employs much of the same structure and has many of the same properties as the embodiments of the air unit 32, 132 described above in connection with FIGS. 1-7. Accordingly, the following description focuses primarily upon structure and features that are different than the embodiments described above in connection with FIGS. 1-7. Reference should be made to the description above in connection with FIGS. 1-7 for additional information regarding the structure and features, and possible alternatives to the structure and features of the air unit 232 illustrated in FIGS. 8-10 and described below. Features and elements in the embodiment of FIGS. 8-10 corresponding to features and elements in the embodiments described above in connection with of FIGS. 1-7 are numbered in the 200 series of reference numbers.

The illustrated air unit 232 includes an upper surface 234, a lower surface 236 and includes a first bellows-shaped portion 240a and a second bellows-shaped portion 240b. The first bellows-shaped portion 240a can be coupled to and a substantially mirror image of the second bellows-shaped portion 240b. In some embodiments, only one bellows-shaped portion is included and can extend over at least a portion of the air unit 232.

A spout 242 can be coupled to the lower surface 236 and can permit entry and egress of fluid therethrough. A substantially cylindrical foam piece 244 (FIGS. 8 and 10) is positioned in the air unit 232 and can substantially extend between the upper surface 234 and the lower surface 236. The foam piece 244 can support the air unit 232 and can permit the air unit 232 to inflate and deflate with less fluid than would be needed if the foam piece 244 were not included. The foam piece 244 can include a substantially vertical aperture 248 extending therethrough to permit the flow of fluid through the aperture and into the air unit 232.

In some embodiments, the air unit 232 bellows-shaped portions 240a, 240b can include a 70-75 A durometer, ether polyurethane material that is very pliable. In other embodiments, another pliable material, such as a polymer, rubber and the like can be used. In some embodiments, the bellows-shaped portions 240a, 240b can have a width of about between about 0.01 inches and about 0.1 inches (between about 0.254 mm and about 2.54 mm). In other embodiments, the width is between about 0.02 inches and about 0.07 inches (between about 0.5 mm and about 1.78 mm). In yet other embodiments, the width is about 0.04 inches (about 1 mm).

In some embodiments, the foam piece 244 can include visco-elastic foam, such as T85-20 visco-elastic foam, which is a relatively pliable memory foam. In some embodiments, the foam piece 244 can have a diameter of about 3 inches (about 7.62 cm). In some embodiments, one or both of the air unit 232 and the foam piece 244 can have other shaped cross-sections, such as triangular, square, ovular, rectangular, pentagonal, or other similar regular and non-regular shapes.

The visco-elastic foam material can possess thermally activated properties which causes the foam surface to conform to the shape of the patient's body. Specifically, the visco-elastic foam can have a lower compression coefficient at an elevated temperature as compared to the compression coefficient at a cooler temperature. The body heat of the patient can act to soften the visco-elastic foam directly supporting the body, while the portion of the cushion not supporting the body remains in a more firm condition. This feature also allows for a more equal distribution of the patient's weight over a greater surface area.

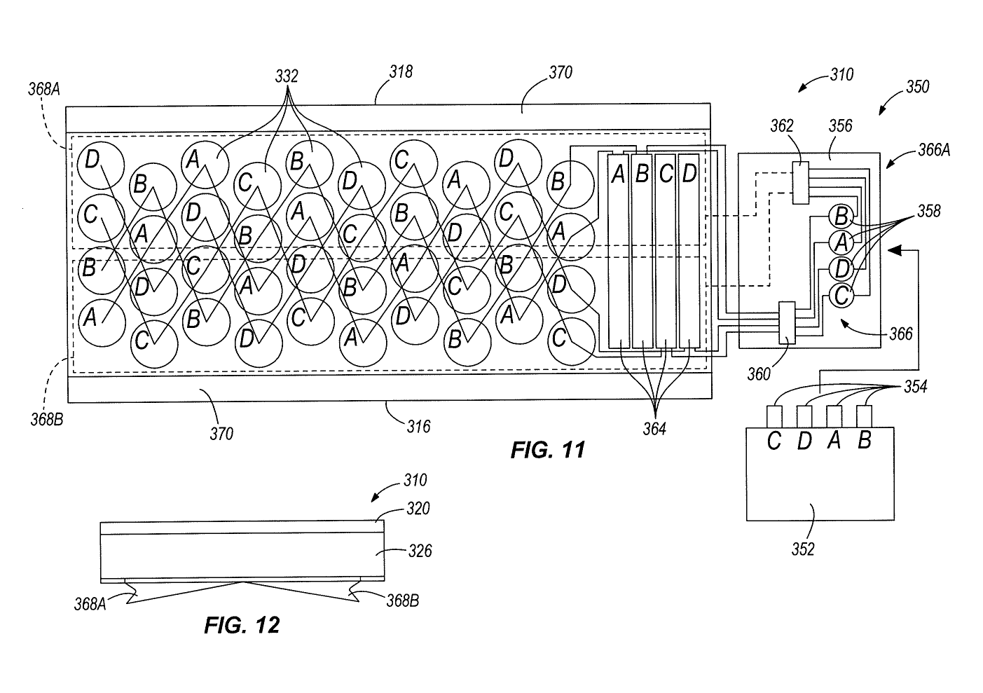

FIGS. 11 and 12 illustrate an embodiment of a body support 310 according to the present invention. This embodiment employs much of the same structure and has many of the same properties as the embodiments of the air units 10, 110, 210 described above in connection with FIGS. 1-10. Accordingly, the following description focuses primarily upon structure and features that are different than the embodiments described above in connection with FIGS. 1-10. Reference should be made to the description above in connection with FIGS. 1-10 for additional information regarding the structure and features, and possible alternatives to the structure and features of the body support 310 illustrated in FIGS. 11 and 12 and described below. Features and elements in the embodiment of FIGS. 11 and 12 corresponding to features and elements in the embodiments described above in connection with of FIGS. 1-10 are numbered in the 300 series of reference numbers.

FIGS. 11 and 12 illustrate a body support 310 that includes a plurality of air units 332 and a control system 350 for controlling inflation and deflation of the air units 332. The control system 350 can include a pump 352 having a plurality of outlets 354, a controller 356 having a plurality of inlets 358 that substantially mate with the pump outlets 354, a first valve 360 and a second valve 362. The first valve 360 controls the flow of fluid between the pump 352 and the air units 332. In some embodiments, the pump 352 is an eight liter/minute alternating pressure pump with a rotary valve cycle. In other embodiments, the pump 352 is a forty liter/minute alternating pressure pump with high flow solenoid valves. An air filter can be coupled to the pump 352 to inhibit debris from entering and clogging the pump 352.

The illustrated body support 310 further includes a plurality of air cells 364 that extend substantially across a width of body support 310 and are operable to support a user's feet and ankles. In other embodiments, the air cells 364 can be eliminated, or more can be included than are illustrated in FIG. 11. The air cells 364 can be inflated and deflated to promote flow of bodily fluids and to limit ulcers in a user's feet and ankles.

The air units 332 can be divided into four different groups, A, B, C and D (see FIG. 11). One of the air cells 364 can be included in each group. Each of the groups A, B, C and D can be controlled by the control system 350. In some embodiments, each of the groups A, B, C, and D can be inflated and deflated independently with respect to at least one of the other groups A, B, C, and D, or can be inflated and deflated to the exclusion of at least one of the other groups A, B, C, and D. To this end, the cells 364 in each group A, B, C, and D can be in fluid communication with one another, but can be isolated from fluid communication with cells 364 of one or more other groups A, B, C, and D.

In some embodiments, the air units of one or more groups A, B, C, and D are arranged in an array. Each array can be in the form of a grid, wherein air units 332 are spaced across a portion or all of the width and length of the body support 310. In such cases, consecutive air units 332 extending in width-wise and length-wise directions along the body support can extend substantially parallel to the width and length of the body support 310 (see FIG. 14, described in greater detail below) or can extend diagonally with respect to the width and length of the body support 310 (see FIG. 11). In any case, the air units 332 of one or more groups A, B, C, and D can be separated by one or more air units 332 from at least one other group A, B, C, and D in one or more directions across the body support 310. In this manner, air units 332 from one or more groups A, B, C, and D can alternate with air units from one or more other groups A, B, C, and D across the length and/or width of the body support 310. This alternating positional relationship of the air units 332 in the groups A, B, C, and D can occur if the body support 310 only has two groups A, B of air units 332, in which case the units can be arranged in a checkerboard fashion, with every other air unit 332 in length-wise and width-wise directions being an air unit from another group. This alternating positional relationship of the air units 332 can also occur if the body support 310 has any other greater number of groups A, B, C, and D.

Although the support 310 illustrated in FIGS. 11 and 12 includes a pump, it should be noted that some embodiments of the present invention are not powered with a pump. Instead, the groups A, B, C, and D of air units 332 within the body support are separated by valves enabling air to move from a first group of air units 332 to one or more other groups of air units 332 responsive to sufficient compression upon the first group of air units 332. Such valves can be any valves capable of permitting airflow upon reaching a pressure differential between opposite sides of the valve, and can be one-way valves or two-way valves. Examples of such valves are “cracking” valves, are well-known to those skilled in the art, and are not therefore described further herein. Such valves can be used to prevent pressure overload of one or more air units 332 or groups of air units 332, thereby functioning as a relief valves for the air units 332. Also, such valves can be selected to have a refill pressure enabling airflow back into the air units 332 following removal of the excess pressure from the air units 332.

In addition to or instead of using valves between one or more air units 332 as just described, valves can be located between any number or all of the air units 332 within one or more groups A, B, C, and D of the body support 310, thereby enabling air (and pressure) to be distributed among the cells of a group A, B, C, and D responsive to pressure exerted upon one or more air units 332 within a group A, B, C, and D. In either case (i.e., using valves between groups of air units 332 and/or using valves between air units 332 of the same group), air can be freely displaced within the support 310 from air unit 332 to air unit 332 to allow for pressure redistribution.

Although the above-referenced body support structure (in which valves separate the groups of air units 332 (or even the cells within one or more of the groups of air units 332) are well-suited for non-powered embodiments of the present invention, such valve and cell arrangements can also be employed in any of the powered support embodiments described and illustrated herein.

The pump 352 can move fluid through the pump outlets 354 and into the controller inlets 358 and through the first valve 360. In some embodiments, the pump 352 moves fluid into a storage tank and when the tank reaches a desired pressure, the pump 352 can be shut off in response to a pressure sensor to conserve energy and reduce noise and vibration. The reservoir can provide and store fluid for the air units 332 and the air cells 364, in response to the controller 356. In some non-powered embodiments, the reservoir can provide and store fluid for the air units 332 and air cells 364 to provide more even support for the user. In some non-powered embodiments, a check valve can be used to prevent most or all of the fluid from flowing out of the air units 332 and the air cells 364 in response to the weight of the user. In some embodiments, the check valve can be a static/dynamic check valve.

Conduit 366 can extend between the controller inlets 358, through the first valve 360 and to the air cells 364 and air units 332, as shown schematically in FIG. 11. The groups of air units 332 are arranged in a random fashion, to promote flow of bodily fluids and to limit movement of a user positioned on the bed. In one embodiment, each of the groups A, B, C and D is controlled to inflate and deflate independent of each of the other groups. In another embodiment, two of the groups are controlled together, such that group A is controlled with group C and group B is controlled with group D, to create two independently controlled groups of air units 332 and air cells 364.

The body support 310 can further include first and second air chambers 368A, 368B for tilting the body support 310 and turning a user. The first and second air chambers 368A, 368B can each have a half-bellows shape, such that when deflated, the chambers 368A, 368B lie substantially flat, and when inflated, the chambers 368A, 368B have a substantially triangular shape (see FIG. 12 illustrating the inflated position). The air chambers 368A, 368B can be coupled to the pump 352 via conduit 366A. Fluid can flow from the pump 352, out the pump outlets 354, into the controller inlets 356, through conduit 366A and through the second valve 362. In the illustrated embodiment, the controller inlets 356A and B can provide the second air chamber 368B with fluid and the controller inlets 356C and D can provide the first air chamber 368A with fluid.

Each of the first and second air chambers 368A, 368B can be inflated to a wedge shape with the narrowest portion of the wedge in the center of the body support 310 and the widest portion of the wedge near the outer edge of the body support 310. The first and second air chambers 368A, 368B can be individually inflated to raise each respective side of the body support 310 to effectively turn a patient on their side to alternate the part of the body which supports the weight. Some patients may also require lateral rotation to drain a buildup of fluid in the lungs. The first and second air chambers 368A, 368B can tilt its respective half of the body support 310 to an angle of approximately thirty degrees from the center of the body support 310.

The body support 310 can include a top foam layer 320 and a bottom foam layer 326. In other embodiments, one or more middle foam layers can be included. The air units 332 can be positioned in the bottom foam layer 326, such that the top foam layer 320 substantially covers the air units 332 to enhance user comfort. In the illustrated embodiment, first and second side foam pieces 370 are included. The side foam pieces 370 can include a more resilient material to more effectively retain a user on the body support 310. In other embodiments, the side foam pieces 370 can be omitted, such as when the body support 310 also omits the first and second air chambers 368A, 368B.

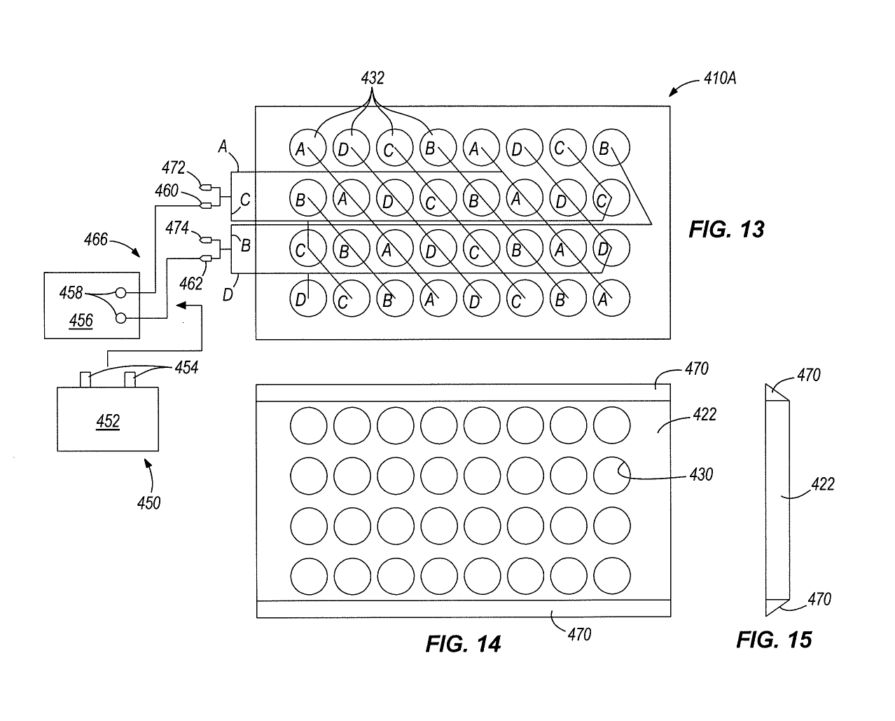

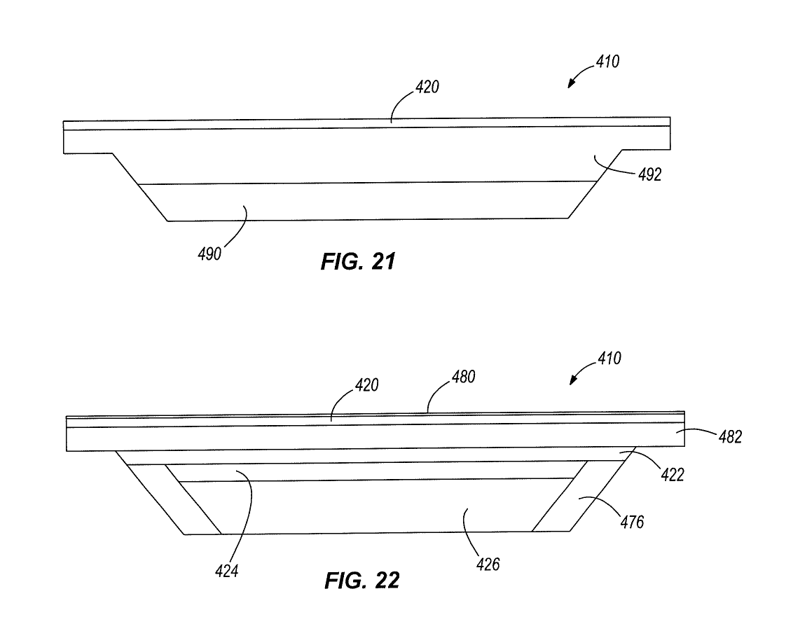

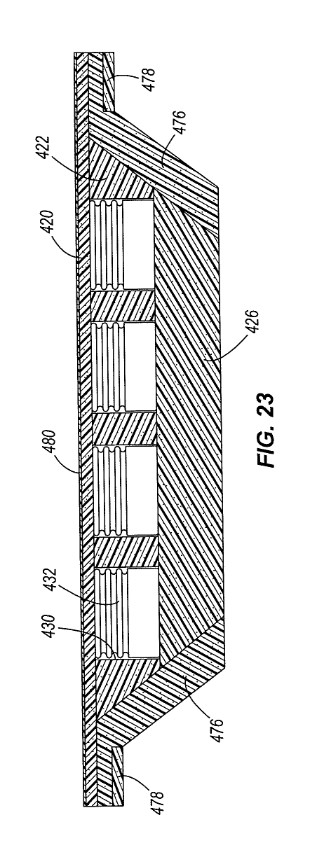

FIGS. 13-23 illustrate another embodiment of a body support 410 according to the present invention. This embodiment employs much of the same structure and has many of the same properties as the embodiments of the body support 10, 110, 210 and 310 described above in connection with FIGS. 1-12. Accordingly, the following description focuses primarily upon structure and features that are different than the embodiments described above in connection with FIGS. 1-12. Reference should be made to the description above in connection with FIGS. 1-12 for additional information regarding the structure and features, and possible alternatives to the structure and features of the body support 410 illustrated in FIGS. 13-23 and described below. Features and elements in the embodiment of FIGS. 13-23 corresponding to features and elements in the embodiments described above in connection with of FIGS. 1-12 are numbered in the 400 series of reference numbers.

FIGS. 13-15 illustrate a first body support portion 410A that includes a middle foam layer 422 having a plurality of apertures 430 sized to receive a plurality of air units 432. The body support portion 410A further includes first and second side foam pieces 470 that can be more resilient than the middle layer 422 and thus inhibit a user from rolling off of the body support 410. As shown in FIG. 15, the side foam pieces 470 can be triangularly-shaped to further inhibit a user from rolling off of the body support 410. A mating frame can be provided to support the triangle-shaped foam pieces 470. Although air chambers are not included in the illustrated embodiment, air chambers can be included to support a user's feet and ankles.

The body support 410 can further include a control system 450 for at least partially controlling inflation and deflation of the air units 432. The control system 450 can include a pump 452 having at least one outlet 454 coupled to a controller 456 having at least one inlet 458. The pump 452 can direct a flow of fluid out the outlet 454 and into the controller 456 via the inlet 458. The controller 456 can be coupled to a first valve 460 and a second valve 462 to direct a flow of fluid through at least one of the first valve 460 and the second valve 462.

The air units 432 can be divided into four different groups, A, B, C and D (see FIG. 13). Each of the groups A, B, C and D can be controlled by the control system 450. In the illustrated embodiment, the groups A, B, C and D are arranged in a diagonal pattern across the body support 410. Other arrangements and configurations of air units 432 are possible and the illustrated configuration is given by way of example only. Since the groups A, B, C and D are arranged diagonally, fluid moves up or down along a user's body and banding of fluid is limited or nonexistent. Fluid can be directed by the controller 456 through the first valve 460, through conduit 466 into air units 432 in groups A and C. Fluid can also be directed from the controller 456 through the second valve 462 and into air units 432 in groups B and D, as illustrated in FIG. 13. In some embodiments, groups A and C are controlled together and groups B and D are controlled together. In other embodiments, each of groups A, B, C and D are independently controlled.

An optional first relief valve 472 can be coupled to the first valve 460 and the conduit 466 to permit excess fluid to flow out of the first relief valve 472. An optional second relief valve 474 can be coupled to the second valve 462 and the conduit 466 to permit excess fluid to flow out of the second relief valve 474. In the illustrated embodiment, the first and second relief valves 472, 474 can be utilized to adjust to a user's weight or to inhibit damage to the air units 432 due to overfilling.

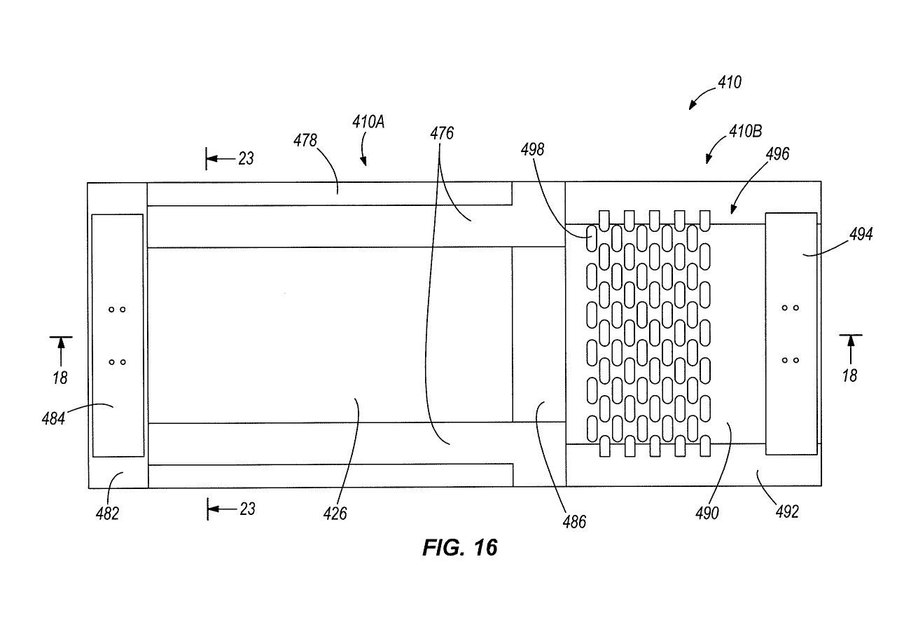

FIGS. 16-19 illustrate the body support 410 including the first body support portion 410A and a second body support portion 410B. The first body support portion 410A is operable to support a user's torso and head, whereas the second body support portion 410B is operable to support a user's legs and feet. The first body support portion 410A includes a bottom layer of foam 426 that can include any of a variety of foam materials. In the illustrated embodiment, the bottom layer of foam 426 includes a polyurethane foam, such as 35185 foam or 36190 IFD 36 1.9 pound density foam, due to the relative light weight of the foam and to inhibit bottoming out of the body support 410, although other suitable supportive foams are possible, and fall within the spirit and scope of the present invention. The bottom layer of foam 426 can extend most of the way across a width of the body support 410 and support the air units 432, as shown in FIGS. 16 and 21-23.

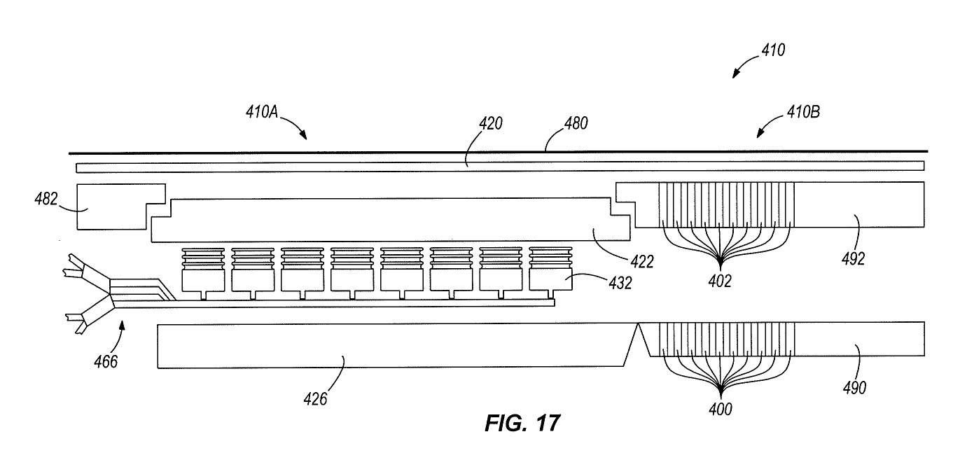

FIGS. 17-23 illustrate the body support 410 further including a top layer of foam 420. The top layer of foam 420 is operable to support a user above the air units 432. The top layer of foam 420 can include any of a variety of foam materials. In some embodiments, the top layer of foam 420 includes a visco-elastic foam material, such as a Tempur high density foam. In some embodiments, the Tempur high density foam has a density of seven pounds. In other embodiments, the top layer of foam 420 can have a gel-like feel to enhance user comfort. In some embodiments, such as those illustrated in FIGS. 17, 19, 22 and 23, a film layer 480 can be coupled to the top layer 420 to enhance stability, durability and to reduce sheer. In some embodiments, the film layer 480 includes a urethane film membrane, such as (for example) a FlexSkin® Membrane. In some embodiments, the film layer 480 simply covers the top layer 420 without being attached thereto, such as in cases where the film layer 480 lays atop the other mattress structure illustrated in FIGS. 16-23 or defines a sleeve or sack into which parts or all of the other mattress structure illustrated in FIGS. 16-23 is enclosed. In other embodiments, however, the film layer 480 is laminated to the top layer 420. An example of a film layer 480 is the urethane-coated stretch knit product sold under the trade name DARTEX, and manufactured by Kirton Healthcare Group Ltd. of the U.K. In some embodiments, the film layer 480 is about 2 mm thick. In some embodiments, the film layer 480 can cover at least a top surface 412 of the body support 410. In other embodiments, the film layer 480 can envelope the top layer 420 and cover at least top and bottom surfaces of the top layer 420. In still other embodiments, the film layer 480 can completely surround the top layer 420 on all sides. In some embodiments, the film layer 480 can include a zipper positioned around the body support 410 to allow for removal for cleaning and the like. In some such embodiments, the zipper can extend around a portion or all of a perimeter of the body support 410. The cover may inhibit travel of moisture from the top surface 412 into the body support 410.

FIGS. 17, 18, 20, 22 and 23 illustrate the body support 410 further including a middle layer of foam 422 that can include a plurality of apertures 430 sized to receive the air units 432. The middle layer of foam 422 can include a variety of materials. In FIG. 20, two such middle layers 422, 424 are included and can comprise the same or different materials. In some embodiments, the middle layer of foam 422 can include a visco-elastic foam material, such as Tempur T85-13 visco-elastic foam that has a 5.25 pound density. In other embodiments, the middle layer of foam 422 can include Tempur T85-20 visco-elastic foam or other similar material operable to provide support and pressure redistribution. In still other embodiments, a non-visco-elastic foam, such as polyurethane foam or conventional foam can be included in the middle layer of foam 422.

FIGS. 16, 19, 20, 22 and 23 illustrate the body support 410 further including a support layer 476 that can be positioned on either side of the body support 410. In the illustrated embodiment, the support layer 476 extends diagonally adjacent the bottom foam layer 426 and the middle foam layer(s) 422, 424. In some embodiments, the support layer 476 can include a more resilient foam to inhibit a user from rolling off the body support 410. In some embodiments, the support layer 476 includes a polyurethane foam, such as IFD 70 2.4 pound density polyurethane foam. In other embodiments, a visco-elastic foam or conventional foam can be included in the support layer 476.

FIGS. 16, 19, 20 and 23 illustrate the body support 410 further including a crosslink microcell foam layer 478 that can provide support and protection for at least one of the edges of the body support 410.

FIGS. 16-20 and 22 illustrate the body support 410 further including a head support layer 482 operable to support a user's head. In some embodiments, the head support layer 482 extends across the width of the body support 410. In some embodiments, the head support layer 482 only extends across a portion of the body support width. The head support layer 482 can include the same or a different material than the middle layer 422 and/or the top layer 420. In some embodiments, the head support layer 482 comprises polyurethane foam, such as IFD 70 2.4 pound density polyurethane foam. In some embodiments, the head support layer 482 comprises a visco-elastic foam or a conventional foam. The head support layer 482 can be operable to secure some of the various layers together. The head support layer 482 can also promote proper head alignment with a user's body.

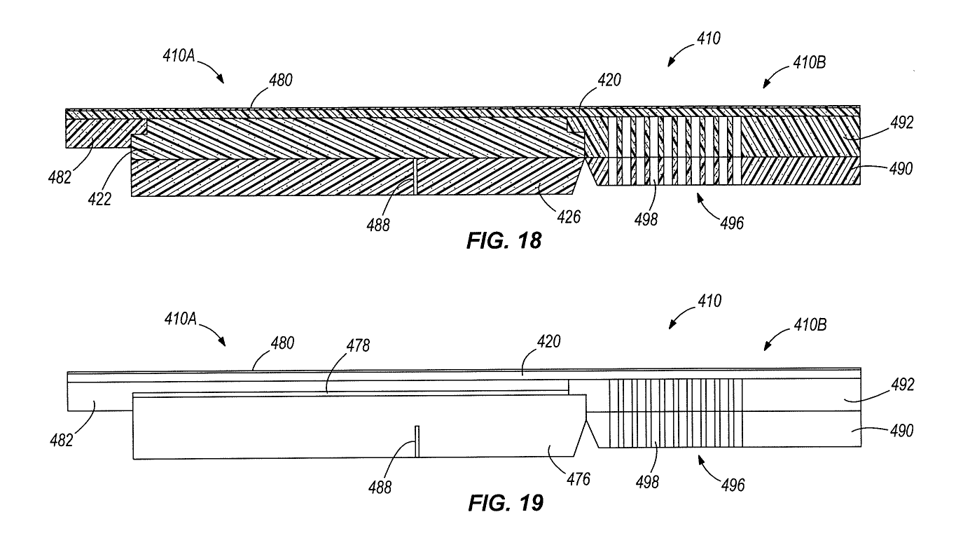

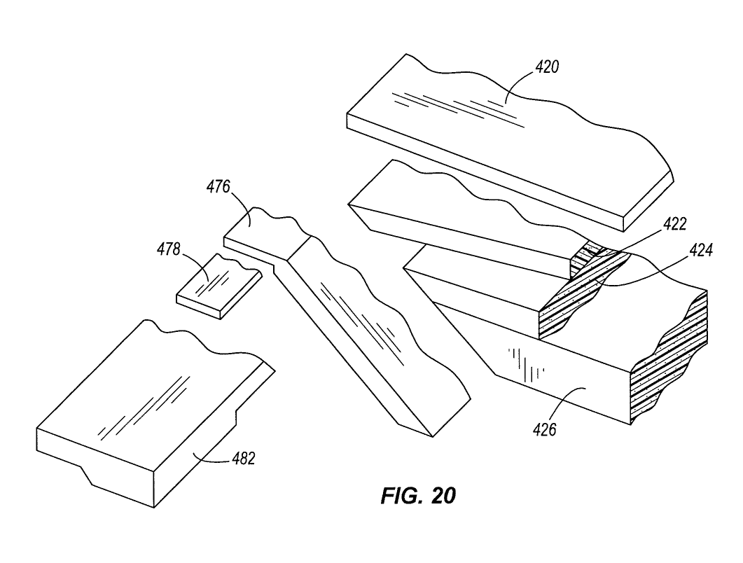

In some embodiments, and as illustrated in FIG. 16, the head support layer 482 can be coupled to a first mounting plate 484. In some embodiments, the first mounting plate 484 can be coupled to a frame to secure the body support 410 to the frame. The mounting plate 484 can retain the head support layer 482 in position on the frame if and when the body support is moved into a sitting position. In some embodiments, and as illustrated in FIG. 16, a seat support 486 can be coupled to the body support substantially between the air units 432 and the second body support portion 410B. The seat support 486 can provide adequate support for a user when the body support 410 is in a flat position or a raised, sitting position. The seat support 486 can inhibit slipping between the body support 410 and the frame and between the user and the body support 410. In articulating embodiments (i.e. body supports 410 capable of moving between flat and non-flat positions), a gap 488 can be cut in the bottom layer 426 and/or the support layer 476 to promote bending of the body support 410 without unnecessary strain on the various layers. One embodiment of the gap 488 is illustrated in FIGS. 18 and 19.

FIGS. 16-19 and 21 illustrate the second body support portion 410B operable to support a user's feet and legs. The second body support portion 410B can include multiple layers of foam and can include at least one inflatable portion, as discussed above with respect to FIGS. 2 and 3. In the illustrated embodiment, the second body support portion 410B includes a lower foam layer 490 extending across part of the width of the second body support portion 410B. The lower foam layer 490 can comprise a conventional foam, such as 21240 conventional foam. In other embodiments, the lower foam layer 490 can comprise a polyurethane foam, such as IFD 24 polyurethane foam. In still other embodiments, the lower foam layer 490 can comprise a visco-elastic foam. The lower foam layer 490 is operable to at least partially support a user's feet and legs and to protect from bottoming out against the frame.

FIGS. 16-19 and 21 further illustrate that the second body support portion 410B can include an upper foam layer 492 supported on, and in some embodiments coupled to, the lower foam layer 490. In the illustrated embodiment, the upper foam layer 492 extends across substantially the entire width of the second body support portion 410B. The upper foam layer 492 can comprise a visco-elastic foam, such as Tempur T85-08 visco-elastic foam. In other embodiments, the upper foam layer 492 can comprise a polyurethane foam or a conventional foam. The upper foam layer 492 can have a lower density and be operable to receive feet, ankles and legs to envelope at least a portion of the feet, ankles and legs to enhance user comfort.

In some embodiments, and as illustrated in FIG. 16, a second mounting plate 494 can be coupled to the second body support portion 410B. In some embodiments, the second mounting plate 494 can be coupled to a frame to secure the body support 410 to the frame. The mounting plate 494 can retain the second body support portion 410B in position on the frame when the body support is moved into a sitting position.

FIGS. 16-19 illustrate the second body support portion 410B including a compression zone 496 operable to support a user's legs, and in some embodiments, feet and ankles. The compression zone 496 can include a plurality of foam pieces 498 extending through apertures 400 in the lower foam layer 490 and apertures 402 in the upper foam layer 492. The foam pieces 498 are removed in FIG. 17 to more clearly illustrate the apertures, 400, 402. In some embodiments, the compression zone promotes flow of fluid in a user's legs and in some embodiments, in a user's heels and ankles.

In some embodiments, the compression zone 496 and the air units 432 can work together to promote flow of fluid in a user's body. In some embodiments, the air units 432, and the compression zone 496 can more evenly support a user than a conventional mattress or body support. For example, some portions of a user's body can feel more pressure than other portions on a conventional mattress. At least some of the embodiments discussed above more evenly support a user and thereby minimize peaks in stress or weight on any portion of the users body. The more even support can enhance flow of fluid throughout the user's body. The various embodiments of air units, cells and chambers can further enhance flow of fluid by preventing or inhibiting banding of fluid between more conventional full length or full width inflatable sacs.

In some embodiments, many or all of the body support components can be antimicrobial to provide a healthier environment for the user. Some embodiments may include an inflatable pillow positioned adjacent a user's head to selectively lift and lower the user's head. The inflatable pillow may be coupled to the air chambers 368 or may be separate therefrom. In some embodiments, the body support 410 can include a heel elevator to raise a user's feet. As with the inflatable pillow, the heel elevator may be coupled to the air chambers 368 or may be separate therefrom.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

For example, the technology of the present invention can provide for a body support performing the function of an air proportioning device capable of both compression and vacuum to alter internal air pressure of each air unit. In some embodiments, such alteration can be on an individual air unit basis. Also, in some embodiments, a pressure feedback system can calculate the loading force of one or more air units or groups of air units over time, and can cause the body support to make adjustments as necessary by adding or removing air pressure to individual air units or groups of air units, thereby effectively changing loading force profiles. The system could also be controlled in a manner which effectively repositions a user on the support, turning to left, right, and center positions.

What is claimed is:

1. A body support for supporting at least a portion of a user, the body support comprising:
a first layer of foam defining a plurality of apertures;
a first plurality of cells at least partially filled with fluid;
a second plurality of cells at least partially filled with fluid, at least one cell of the second plurality of cells positioned between two cells of the first plurality of cells;
a second layer of foam covering the first and second plurality of cells; and
a control system operable to selectively inflate at least one of the cells in the first plurality of cells to the exclusion of at least one of the cells in the second plurality of cells, and to selectively inflate at least one of the cells in the second plurality of cells to the exclusion of at least one of the cells in the first plurality of cells, wherein inflation of a cell in either plurality of cells biases at least a portion of the second layer of foam with respect to the first layer of foam.

2. The body support of claim 1, wherein in at least one state of the body support, the first plurality of cells is blocked from fluid communication with the second plurality of cells.

3. The body support of claim 1, wherein each cell contains foam.

4. The body support of claim 3, wherein each cell has a substantially cylindrical shape defining a longitudinal axis of each cell, and wherein at least a portion of the length of each cell is substantially filled with a cylindrical piece of foam.

5. The body support of claim 3, wherein the foam within each cell comprises a layer of a first foam and an underlying layer of second foam different from the first foam.

6. The body support of claim 3, further comprising an elongated aperture extending through the foam through which fluid can flow.

7. The body support of claim 3, wherein the foam within each cell is spaced a distance from the top surface of the cell.

8. The body support of claim 1, wherein each cell of the first and second plurality of cells has a portion that expands and contracts in length responsive to fluid pressure changes in the cell to extend and contract a portion of the cell out of and into an aperture of the first foam layer, respectively.

9. The body support of claim 8, wherein expansion of each cell of the first and second plurality of cells causes the second foam layer to be lifted in a direction away from the first foam layer.

10. The body support of claim 8, wherein contraction of each cell of the first and second plurality of cells causes the second foam layer to be retracted below a position in which the second foam layer is substantially flat.

11. The body support of claim 1, wherein the cell includes a cylindrical portion and a bellows shaped portion.

12. The body support of claim 1, wherein the first layer of foam comprises visco-elastic foam substantially surrounding vertical walls of each cell.

13. The body support of claim 1, wherein the cell includes a port in a bottom surface of the cell.

14. The body support of claim 1, further comprising a third layer of foam located between the first and second layers of foam and defining a plurality of apertures therethrough substantially aligned with the plurality of apertures in the first layer of foam, wherein the first and second pluralities of cells extend through the plurality of apertures in the third layer of foam.

15. The body support of claim 1, wherein the first and second pluralities of cells are positioned in respective arrays across the body support.

16. The body support of claim 1, wherein the cells of the first and second pluralities of cells alternate in position with respect to one another across at least one of a length and a width of the body support.

17. A body support for supporting at least a portion of a user, the body support comprising:
a plurality of cells each having an upper surface and a lower surface, the plurality of cells including a first plurality of cells each individually covered and surrounded by foam and a second plurality of cells each individually covered and surrounded by foam, the first plurality of cells and the second plurality of cells positioned such that any two cells of the first plurality of cells are separated by at least one cell of the second plurality of cells;
a pump; and
a control system coupled to the pump and operable to inflate the first plurality of cells to the exclusion of the second plurality of cells, and to inflate the second plurality of cells to the exclusion of the first plurality of cells;
wherein each cell defines a first height when deflated and a greater second height when inflated to lift and lower foam covering the cell and to thereby change the shape of a top surface of the body support.

18. The body support of claim 17, wherein the foam covering each of the plurality of cells is a layer of foam extending across the plurality of cells.

19. The body support of claim 17, wherein the first and second pluralities of cells are positioned in respective arrays across the body support.

20. The body support of claim 17, wherein the cells of the first and second pluralities of cells alternate in position with respect to one another across at least one of a length and a width of the body support.

21. The body support of claim 17, further comprising:
a first bladder selectively inflatable by the control system to tilt the body support in a first direction; and
a second bladder selectively inflatable by the control system to tilt the body support in a second direction.

22. A method of changing pressure points on a user's body against a body support, the method comprising:
inflating a first plurality of cells separated from the user's body by a layer of foam and each individually surrounded by foam;
lifting first areas of the layer of foam atop each of the first plurality of cells by inflating the first plurality of cells;
increasing pressure exerted upon the user's body by the body support at the first areas of the layer of foam by lifting the first areas of the layer of foam;
deflating the first plurality of cells;
lowering the first areas of the layer of foam by deflating the first plurality of cells;
decreasing pressure exerted upon the user's body by the body support at the first areas of the layer of foam by lowering the first areas of the layer of foam;
inflating a second plurality of cells to at a time when the first plurality of cells are deflating or are deflated, each of the second plurality of cells individually surrounded by foam, separated from the user's body by the layer of foam, and separated from adjacent cells of the second plurality of cells by at least one cell of the first plurality of cells;
lifting second areas of the layer of foam atop each of the second plurality of cells by inflating the second plurality of cells; and
increasing pressure exerted upon the user's body by the body support at the second areas of the layer of foam by lifting the second areas of the layer of foam.
